(19) United States
(12) Patent Application Publication
(10) Pub. No.: US 2004/0137990 A1
(43) Pub. Date: Jul. 15, 2004

(54) Internal vibration absorber

(75) Inventors: Udo Gartner, Sannerz (DE); Joachim Schneider, Bad Soden-Salmunster (DE); Anton Wolf, Gelnhausen (DE)

Correspondence Address: BURNS DOANE SWECKER & MATHIS L L P, POST OFFICE BOX 1404, ALEXANDRIA, VA, 22313-1404, US

(73) Assignee: WOCO AVS GmbH, Bad Soden-Salmunster (DE)

(21) Appl. No.: 10/745,628

(22) Filed: Dec. 29, 2003

Related U.S. Application Data
(63) Continuation of application No. 10/224,448, filed on Aug. 21, 2002.

(30) Foreign Application Priority Data
Aug. 22, 2001 (DE) 101 42 822.7

(51) Int. Cl. F16D 3/52

(52) U.S. Cl. 464/89

(57) ABSTRACT

An internal vibration absorber, configured to be installed in hollow shafts, includes a central absorber mass, a rigid outer shell coaxially surrounding the absorber mass, and an elastomeric spring element interconnecting the central mass and the outer shell in an elastic/resilient manner. The elastomeric spring element includes circumferentially spaced resilient radial spacers, which are functionally independent from one another. The radial spacers may extend axially along the entire length of the absorber mass, or the spacers may engage the absorber mass at axially spaced apart locations. All spacers engage axially the central absorber mass at such a distance apart that an appreciable wobbling of the absorber mass within the shell is impossible even when the absorber mass is in soft resilient suspension.

This application claims priority under 35 U.S.C. §119 and/or 365 to patent application Ser. No. 101 42 822.7 filed in Germany on Aug. 22, 2001.

### BACKGROUND OF THE INVENTION

The invention relates to an internal vibration absorber.

Internal vibration absorbers have been disclosed, for example, in the German Laid-Open Patent Applications DE 36 32 418, DE 37 06 135, DE 197 33 478 and U.S. Pat. No. 6,312,340.

In this context, an internal vibration absorber constitutes an absorber for resonance vibrations and is designed to be installed within the cavity of a hollow component that is, as a rule, biased by vibration under operational conditions. This vibration absorber is provided with an absorber mass as an essential functioning element, which is coupled elastically to the component that is to be damped against vibration via the inner wall of the cavity.

Such hollow components, which are biased by vibrations during normal operation, are in particular hollow drive shafts, and more specifically, hollow axle supports in vehicle construction or generally hollow struts and hollow profiles of any kind, which may be exposed to axial vibrations partly through their inherent rotation or partly in static conditions. Such axial vibrations are particularly critical when their frequency spectrum reaches the resonance range of said hollow components.

It is the object of the present “internal absorber” to suppress the development of vibration overshoots occurring in such a manner.

The internal absorber disclosed in U.S. Pat. No. 6,312,340 is equipped with an absorber mass, which is designed in the shape of a dumbbell and which is received via a disk-shaped coupling spring in the region of its axially central constriction. The absorber mass, with its two heavy end pieces, is thus mounted at the center on its relatively thin connection pieces in the homogenous rubber damping disk in the form of a swing whereby said rubber damping disk causes a whipping vibration of the absorber mass within the cavity about a central whipping nodal point already at moderately large radial components of the influencing force. This leads to considerable wobbling of the absorber mass in case of the absorber disclosed in the patent document DE 197 26 293 (corresponding U.S. Pat. No. 6,312,340) being installed in the hollow drive shaft of a truck, for example, which is influenced by pitching vibrations at heavy loads or during operation in the open terrain. This situation becomes critical especially when the wobbling absorber mass system falls within the range of the inherent resonance frequency.

Based on this state of the art, the invention has as its technical object to provide an internal absorber having a movable inner absorber mass that stabilizes against the development of wobbling oscillations whereby such stabilization does not lead to immobilization or stiffening of the suspension means of the absorber mass.

### SUMMARY OF THE INVENTION

The above object is achieved in that the invention provides a vibration absorber mountable within a hollow member that is subjected to vibrations during operation. The vibration absorber comprises a generally cylindrical interior absorber mass defining a longitudinal axis, the axis having a constant cross-sectional shape and size along its entire longitudinal length. A rigid outer shell coaxially encompasses the absorber mass along substantially the entire longitudinally length of the absorber mass. An elastomeric spring element is disposed between, and interconnects an inner surface of the shell and an outer surface of the absorber mass. The spring element comprises a plurality of spacers extending between the inner and outer surfaces in a direction that is generally radial with reference to the longitudinal axis. The spacers extend along the entire longitudinal length of the absorber mass, or they engage the absorber mass at axially spaced locations, for restraining the absorber mass against wobbling about a whipping nodal point.

In contrast to prior art, the absorber mass of the invention is configured along its entire axial length with constant axial gradients of the mass, in other words, not with all its surface in one elastomeric spring block. Rather, the mass is suspended on radial spacers, which are designed to be either axially sufficiently long, or engaging the absorber mass axially at locations spaced a distance apart so that no appreciable wobbling of the absorber mass about a central whipping nodal point can occur.

According to one embodiment of the invention, there are elastomeric damping stops provided, which are specifically attached to the inner wall of the outer shell and which are designed to be independent from the elastomer spring element of the absorber, whereby said elastomeric damping stops serve to limit vibration overshoots of the absorber mass within the outer shell perpendicular to the longitudinal axis of the internal absorber.

According to an additional embodiment of the invention, said elastomeric damping stops are fixed to the inner wall of the outer shell and they project radially toward the inside, between two neighboring radial spacers of the elastomer absorber spring element, into the absorber itself in such a manner that they simultaneously serve as rotational movement limiting elements for the absorber mass.

### BRIEF DESCRIPTION OF THE DRAWINGS

In the following, the invention is explained in more detail with the aid of preferred embodiment examples in conjunction with the drawings.

FIG. 1 shows in a radial sectional view a first embodiment example of an internal absorber with the characteristics of the invention.

FIG. 2 shows an axial section along the line II-II in FIG. 1.

FIG. 2A is a view similar to FIG. 2 of a slightly modified shell portion.

FIG. 3 shows a side view of a second embodiment example of the internal absorber with the characteristics of the invention.

FIG. 4 shows a third embodiment example of the invention in a top view toward one of the two opposite end sides.

FIG. 5 shows a section along the line V-V in FIG. 4.

### DETAILED DESCRIPTION OF PREFERRED EMBODIMENTS OF THE INVENTION

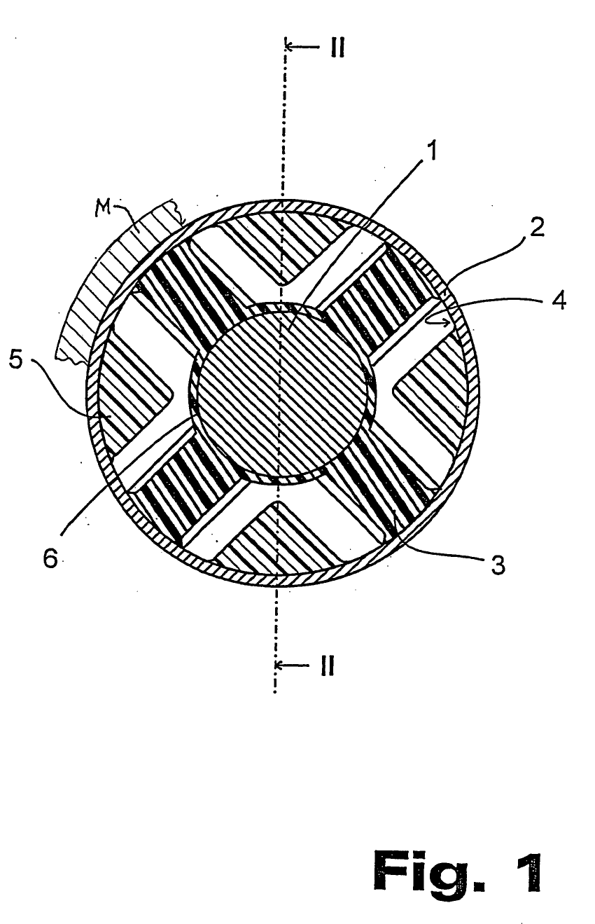

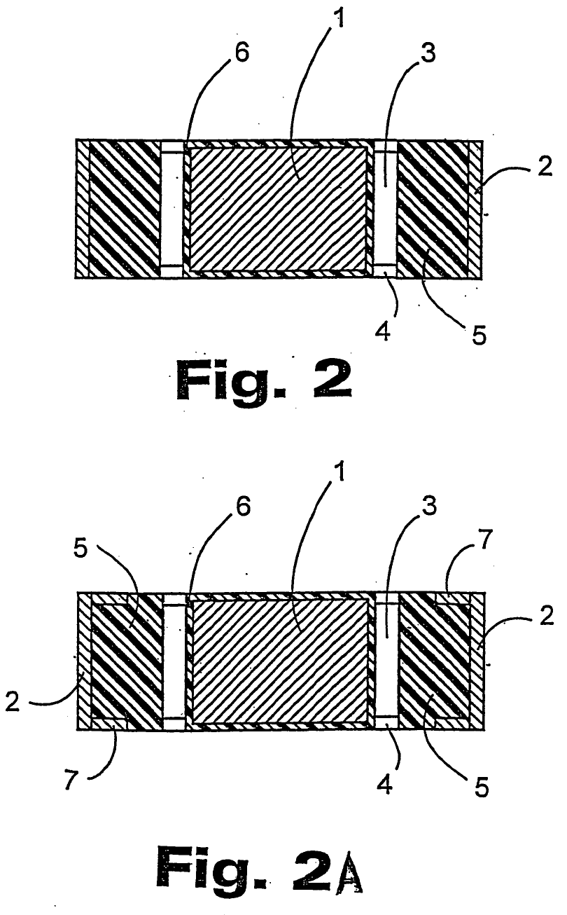

In the first embodiment example (FIG. 1 and FIG. 2) of the internal absorber, having the characteristics of the invention, there is shown in FIG. 1 a radial sectional view of the absorber and in FIG. 2 there is shown an axial section of the absorber. The internal absorber consists of an absorber mass 1, an outer shell 2, and an elastomer spring element connecting these two elements with one another whereby said elastomer spring element is in the form of a sequence of radial spacers 3 that are arranged at equal angular distances from one another.

The shell 2 is adapted to be connected to an inner surface of a hollow member M which, in operation is biased by vibrations, such as a cylindrical vehicle drive shaft. A fragment of that member M is depicted in FIG. 1.

Stop ribs 5 are molded to the inner wall 4 of the shell 2 between two juxtaposed radial spacers 3. These elastomeric damping stops 5 serve as radial impact dampers for the absorber mass 1, which means they serve as movement limiting devices against excess oscillation of the absorber mass 1 from its static position. Said elastomeric damping stops 5 serve also as torsional movement limiting devices, which means they function as rotation stops for large and extreme torsional vibration amplitudes of the absorber mass within the shell.

In this regard, it must be pointed out that the illustration of the radial cross section of the absorber in FIG. 1 is not drawn to scale, but it serves the purpose to understandably explain the principles of the internal absorber with its characteristics of the invention. It is particularly a question of the shape and size of the elastomeric radial spacers 3 in how much torsional vibrations of the absorber mass 1 should be either allowed or be suppressed.

Since the absorber mass 1 will consist mostly of economically priced steel, it is for this purpose completely coated with a thin elastomer layer 6 for the purpose of corrosion protection.

If the outer shell 2 is not made of stainless steel (as a general rule it consists of hard synthetic material or stainless steel) then it is practical to protect it also with a thin elastomer layer.

The absorber mass 1 and the outer shell 2 are arranged coaxially to one another in a manner shown in FIG. 2 and they are essentially of the same axial length. The stop ribs 5 extend practically along the entire length of the rigid outer shell 2. For the purpose of axial stabilization, the elastomeric stop elements 5 can be stabilized by flange sections 7 as indicated in a schematic manner in FIG. 2A whereby said flange sections 7 are integrally formed onto the rigid outer shell 2 in one piece.

The spacers 3 are coextensive with one another along the longitudinal axis of the mass 1 as is evident from FIG. 2.

As can be additionally seen in FIG. 2, the radial spacers 3 extend along the entire axial length of the absorber mass as well as along the outer shell 2. The fact that, as can be seen in FIG. 2, said radial spacers 3 are designed actually a little shorter in the axial direction than the exact axial extension of the absorber mass 1 and the outer shell 2, has two reasons: for one, deformation of the radial spacers 3 past the frontal plane of the outer shell 2 is prevented during axial vibrations of the absorber mass 1 within the outer shell 2, and secondly, the measuring of the actual axial extension of the radial spacers is used as an effective influence factor in the resonance adjustment of the absorber.

From the standpoint of wobble stabilization of the absorber mass 1, the radial spacers 3 should be as long as possible and have at most, the same axial extension as the absorber mass; however, said radial spacers should preferably be designed slightly shorter than the axially extended absorber mass but long enough so that pitching or wobbling of the absorber mass within the outer shell 2 about a whipping nodal point (as can occur, for example in the device of U.S. Pat. No. 6,312,340) is made absolutely impossible as an operational condition, and for which the internal absorber is respectively adjusted. The axial dimension of the radial spacers, which is to be maintained by those skilled in the art by way of adjustment of the internal absorber, should therefore lie between half the length and the entire axial length of the absorber mass.

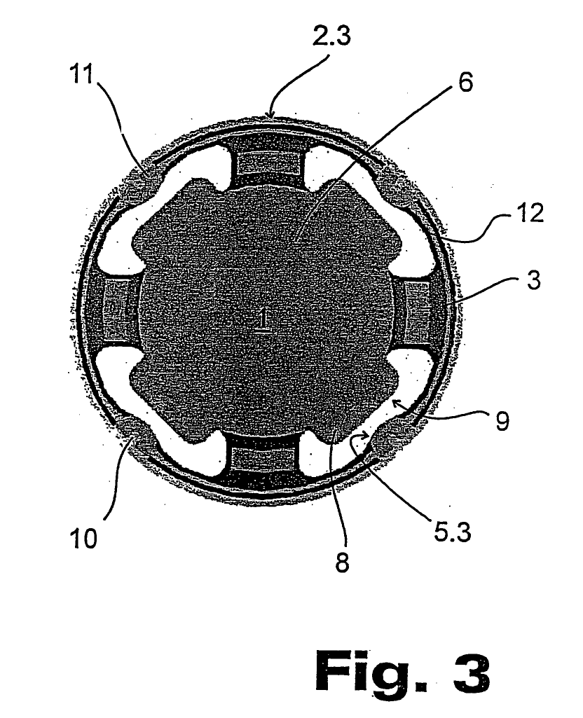

Another embodiment of an internal absorber, having the characteristics of the invention, is shown in a side view in FIG. 3. A configuration of this kind is recommended when comparatively large absorber masses 1 are to be fitted in an outer shell 2.3 that has to be dimensioned relatively small (narrow). The absorber mass 1 shown in FIG. 3 is also coated with a homogenous, dense, and thin elastomer layer 6 for the purpose of corrosion protection, just the same as the absorber mass 1 illustrated in FIG. 1 and FIG. 2. While the absorber mass 1 is of cylindrical shape in the embodiment of FIG. 1 and FIG. 2, which means rotationally-symmetrical, the absorber mass 1 of the internal absorber shown in FIG. 3 is designed having four quarters and being revolvingly symmetrical. On the basic cylindrical form, there are four massive absorber ribs 8 molded thereto which are respectively offset by 90 degrees to one another and which extend along the entire axial length of the absorber mass 1. In this way, the mass of the absorber may be considerably increased compared to a cylindrical absorber mass, without having to noticeably limit the radial oscillation deflection (amplitude) of the absorber mass that is available in the narrowly dimensioned outer shell 2.3. This is achieved in that the mass ribs 8 of the absorber mass 1 are respectively arranged angle-symmetrical between two radial spacers 3 and are oriented in the direction of the angle, whereby said mass ribs 8 extend radially outward into the free space between two juxtaposed radial spacers.

Contours of the mass ribs 8 are configured in a radial section in such manner that they act as torsional vibration limiting devices for the torsional vibration of the absorber mass 1 in cooperation with the sides of the bordering radial spacers 3. Said mass ribs 8 with their flat back ridges 9, which are disposed radially and oriented outwardly, act as movement limiting devices for the translational oscillation of the absorber mass 1 perpendicular to the longitudinal axis of the internal absorber in cooperation with the elastomeric damping stops 5.3, which are arranged on the inner wall of the outer shell 2.3.

Ribs 10 which serve as basic structures for the stops 5.3, extend along the entire length of the outer shell 2.3 and are molded as one piece onto the inner wall of said shell 2.3. An elastomeric cushion 11 is then added to said ribs 10 so that said stops 5.3 constitute spacers that are formed by the ribs 10 and the resilient elastomeric covers 11.

Since the outer shell 2.3 in the embodiment example shown in FIG. 3 consists of rigid synthetic material, it does not need an elastomeric cover for corrosion protection. This, in turn, makes possible an economical manufacturing process for the internal absorber shown in FIG. 3 in a manner whereby the whole elastic material needed for manufacturing of the absorber is injection-molded and uniformly cross-linked in a single injection phase. From a purely chemical standpoint, the lining of the inner wall 12 of the outer shell 2, the elastomer layer 11 of the stop ribs 5.3, the radial spacers 3, and the elastomeric coating of the absorber mass 1 (serving for corrosion protection) form a coherent and continuous cross-linked and uniform elastomer structure, which fulfills the described specific functions relative to vibrations in a relatively independent manner from one another based on the configuration and dimensioning.

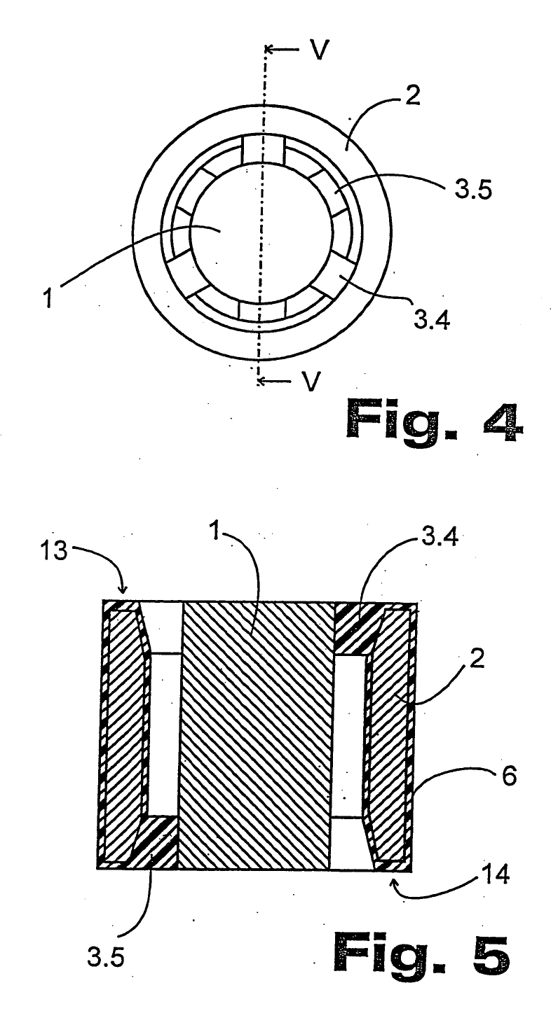

In FIG. 4 and FIG. 5 there is shown another embodiment example of the internal absorber in a frontal view (FIG. 4) and in an axial sectional view (FIG. 5). In contrast to the absorber shown in FIG. 1 through FIG. 3, the radial spacers 3.4 and 3.5 of the absorber, according to the invention, and as shown in FIG. 4 and FIG. 5, are not longitudinally coextensive, but rather are axially spaced apart, as well as being angularly (circumferentially) offset. More particularly, a series of short padlike radial spacers 3.4 and 3.5 are respectively arranged in the two axially opposed end areas 13, 14 of the absorber shell 2, whereby the absorber mass is restrained against wobbling about a whipping nodal point. In each of these two radial planes, there are respectively arranged three radial spacers 3.4 or three radial spacers 3.5 at an equal angular distance from one another. Relative to one another, the two circumferential rows of three spacers are offset angularly from one another by 60 degrees in each of the two planes, in other words, they are in the “open space”. A wobble-free and easily adjustable configuration of an internal absorber is achieved as well with this arrangement of radial spacers 3 suspending the absorber mass 1 within the rigid absorber shell 2.

The basic advantages of the invention can be realized with all three embodiment examples shown above, namely the simple manufacturing of axially short, efficient internal absorbers with large absorber masses mounted in a wobble-free manner.

The internal absorber, having the characteristics of the invention, which is to be installed as resonance vibration absorbers in hollow shafts, comprises a central absorber mass, a rigid outer shell coaxially surrounding said absorber mass, and an elastomeric spring element connecting these two components with one another in an elastic/resilient manner. The elastomer spring element is divided by a series of resilient radial spacers, which are functionally independent from one another and which are disposed in the radial plane in angular direction. Said resilient radial spacers may extend axially along the length of the absorber mass; however, they may also be designed axially-symmetrical and segmented relative to the absorber's center of gravity. It is of significance that all spacers engage axially the central absorber mass along such a long axial distance, or at places spaced at such a distance apart that wobbling of an absorber mass about a whipping nodal point within the shell is made impossible even when the absorber mass is in soft resilient suspension.

Although the present invention has been described in connection with preferred embodiments thereof, it will be appreciated by those skilled in the art that additions, deletions, modification, and substitutions not specifically described may be made without departing from the spirit and scope of the invention as defined in the appended claims.

What is claimed is:

1. A vibration absorber comprising:
a generally cylindrical interior absorber mass defining a longitudinal axis, and having a constant cross-sectional shape and size along its entire longitudinal length;
a rigid outer shell coaxially encompassing the absorber mass along substantially the entire longitudinal length of the absorber mass, the outer shell including an outer surface adapted to be fixed to an inner surface of a hollow member that is subjected to vibration during operation; and
an elastomeric spring element disposed between, and interconnecting, an inner surface of the shell and an outer surface of the absorber mass, wherein the elastomeric spring element comprises a plurality of spacers extending between the inner and outer surfaces in a direction that is generally radial with reference to the longitudinal axis, the spacers extending along the entire longitudinal length of the absorber mass for restraining the absorber mass against wobbling about a whipping nodal point.

2. The vibration absorber according to claim 1 wherein the spacers are equidistantly spaced apart in a circumferential direction with reference to the axis.

3. The vibration absorber according to claim 1 wherein the spacers are coextensive with each other along the longitudinal axis.

4. The vibration absorber according to claim 1 wherein the number of spacers is in a range of two to eight.

5. The vibration absorber according to claim 4 wherein the range is three to four.

6. The vibration absorber according to claim 1, further including elastomeric damping stops arranged in respective spaces formed between adjacent spacers for limiting, independently of the spring element, vibration overshoots of the absorber mass in a direction perpendicularly to the longitudinal axis.

7. The vibration absorber according to claim 6 wherein the stops are mounted to the inner surface of the outer shell.

8. The vibration absorber according to claim 1, further including elastic, impact-resistant ribs fixed to the inner surface of the outer shell and projecting radially inwardly to a location spaced from the absorber mass by a distance defining an allowable vibration amplitude, the ribs disposed between adjacent ones of the spacers and extending along the entire longitudinal length of the outer shell.

9. The vibration absorber according to claim 1 where at least the outer shell and the absorber mass are coated with an elastomeric corrosion-resistant coating.

10. A vibration absorber comprising:
a generally cylindrical interior absorber mass defining a longitudinal axis, and having a constant cross-sectional shape and size along its entire longitudinal length;
a rigid outer shell coaxially encompassing the absorber mass along substantially the entire longitudinal length of the absorber mass, the outer shell including an outer surface adapted to be fixed to an inner surface of a hollow member that is subjected to vibration during operation; and
an elastomeric spring element disposed between, and interconnecting, an inner surface of the shell and an outer surface of the absorber mass, wherein the elastomeric spring element comprises a plurality of spacers extending between the inner and outer surfaces in a direction that is generally radial with reference to the longitudinal axis, the spacers engaging the absorber mass at axially spaced apart locations for restraining the absorber mass against wobbling about a whipping nodal point.

11. The vibration absorber according to claim 10 wherein the spacers are coextensive with each other along the longitudinal axis.

12. The vibration absorber according to claim 10 wherein the number of spacers is in a range of two to eight.

13. The vibration absorber according to claim 12 wherein the range is three to four.

14. The vibration absorber according to claim 10, further including elastomeric damping stops arranged in respective spaces formed between adjacent spacers for limiting, independently of the spring element, vibration overshoots of the absorber mass in a direction perpendicularly to the longitudinal axis.

15. The vibration absorber according to claim 4 wherein the stops are mounted to the inner surface of the outer shell.

16. The vibration absorber according to claim 10, further including elastic, impact-resistant ribs fixed to the inner surface of the outer shell and projecting radially inwardly to a location spaced from the absorber mass by a distance defining an allowable vibration amplitude, the ribs disposed between adjacent ones of the spacers and extending along the entire longitudinal length of the outer shell.

17. The vibration absorber according to claim 10 where at least the outer shell and the absorber mass are coated with an elastomeric corrosion-resistant coating.
